(19) United States
(12) Patent Application Publication
(10) Pub. No.: US 2025/0153130 A1
(43) Pub. Date: May 15, 2025

(54) METHODS OF OPERATING GAS DISTRIBUTORS

(71) Applicant: Dow Global Technologies LLC, Midland, MI (US)

(72) Inventors: Matthew T. Pretz, Lake Jackson, TX (US); Liwei Li, Houston, TX (US); Yu Liu, Lake Jackson, TX (US); Quan Yuan, Sugarland, TX (US); Rami H. Sabbah, Midland, MI (US); Yuan Yao, Missouri City, TX (US); Chi-Wei Tsang, Lake Jackson, TX (US)

(73) Assignee: Dow Global Technologies LLC, Midland, MI (US)

(21) Appl. No.: 18/862,013

(22) PCT Filed: May 5, 2023
(86) PCT No.: PCT/US2023/021191

§ 371 Date: Oct. 31, 2024

Related U.S. Application Data
(60) Provisional application No. 63/340,675, filed on May 11, 2022.

(51) Int. Cl. B01J 8/18

(52) U.S. Cl. CPC B01J 8/1827; B01J 8/1809; B01J 2208/00902; B01J 2208/00938; B01J 2219/00247

(57) ABSTRACT

According to embodiments disclosed herein, a method of operating gas distributers may include passing a solid particulate to a processing unit, where the processing unit includes at least a first distributor and a second distributor, wherein the first distributor and second distributor is operable to pass a combustible gas and a decoking gas into the processing unit, passing the combustible gas into the processing unit through the first distributor, wherein the combustible gas is contacted with the solid particulate and coke forms on the first distributor, halting the passing of the combustible gas through the first distributor while the combustible gas is passed through the second distributor, passing the decoking gas through the first distributor while the combustible gas is passed through the second distributor, wherein the decoking gas removes coke formed on the first distributor, and resuming the passing of the combustible gas through the first distributor.

### CROSS-REFERENCE TO RELATED APPLICATIONS

This application claims priority to U.S. Provisional Application No. 63/340,675 filed May 11, 2022, the entirety of which is incorporated by reference herein.

### TECHNICAL FIELD

The present disclosure generally relates to chemical processing and, more specifically, to the processing of solid particulates in a chemical process.

### BACKGROUND

Numerous chemical processes, such as catalyzed reactions, utilize solid particulates. Sometimes in such processes, these solid particulates must be regenerated, reheated, etc. Some regeneration/reheating processes involve the burning of coke, or the burning of a supplemental fuel. Other solid particulates may be regenerated by contact with a gas, such as if a solid particulate is to be oxidized or reduced.

### SUMMARY

The formation of coke can occur on gas distributors when a combustible gas is passed through a distributor and into a processing unit. For example, a combustible gas that includes ethane may form ethylene when heated, which may be a coke precursor. The formed coke can continue to grow and plug up the orifices in the distributors, thus causing inefficient distribution of gas into the processing unit. Many different decoking techniques can be used to remove the formed coke from the distributors. However, these conventional decoking techniques require the shutdown of the process in order to remove coke from the distributors in scheduled cleanings. As such, new decoking techniques are needed in order to prevent process shutdowns in order to clean coke off of distributors.

Embodiments of the present disclosure provide a method of injecting combustible gas and decoking gas through a plurality of distributors in a processing unit. In some embodiments, the combustible gas may stop passing to the distributor that has formed coke and continue to pass to all other distributors. The decoking gas may then pass to one or more distributors that have formed coke in order to remove the coke. The combustible gas may then again pass to the distributor now partially or fully cleared of coke. This method may provide for an increase in production of the processing unit since combustible gas does not have to stop passing to all distributors in the processing unit in order to remove coke from other distributors. In such embodiments, the system may run without shutdown where the use of decoking gas is cycled through the distributors, allowing for normal operation of the process while decoking takes place.

According to one or more embodiments of the present disclosure, a method for operating gas distributors may comprise passing a solid particulate to a processing unit, where the processing unit comprises at least a first distributor and a second distributor, wherein each of the first distributor and second distributor is operable to pass a combustible gas and a decoking gas into the processing unit, passing the combustible gas into the processing unit through the first distributor, wherein the combustible gas is contacted with the solid particulate and coke forms on the first distributor, halting the passing of the combustible gas through the first distributor while the combustible gas is passed through the second distributor, passing the decoking gas through the first distributor while the combustible gas is passed through the second distributor, wherein the decoking gas removes the coke formed on the first distributor, and resuming the passing of the combustible gas through the first distributor.

These and other embodiments are described in more detail in the Detailed Description. It is to be understood that both the foregoing general description and the following detailed description present embodiments of the presently disclosed technology, and are intended to provide an overview or framework for understanding the nature and character of the technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently disclosed technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and wherein:

FIG. 1 schematically depicts a processing unit with distributors in a process step where the combustible gas is passed through one or more distributors in a processing unit, according to one or more embodiments disclosed herein;

FIG. 2 schematically depicts a processing unit with distributors in a process step where the passing of combustible gas is halted through one distributor in a processing unit and purge gas is passed through that one distributor, according to one or more embodiments disclosed herein;

FIG. 3 schematically depicts a processing unit with distributors in a process step where the passing of the combustible gas and the purge gas is halted through one distributor and the decoking gas is passed through that one distributor, according to one or more embodiments disclosed herein;

FIG. 4 schematically depicts a processing unit with distributors in a process step where the passing of the combustible gas and the decoking gas is halted through one distributor and the purge gas is passed through that one distributor, according to one or more embodiments disclosed herein; and

FIG. 5 schematically depicts a processing unit with distributors in a process step where the passing of decoking gas and purge gas is halted through one distributor and the combustible gas is passed through that one distributor, according to one or more embodiments disclosed herein.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

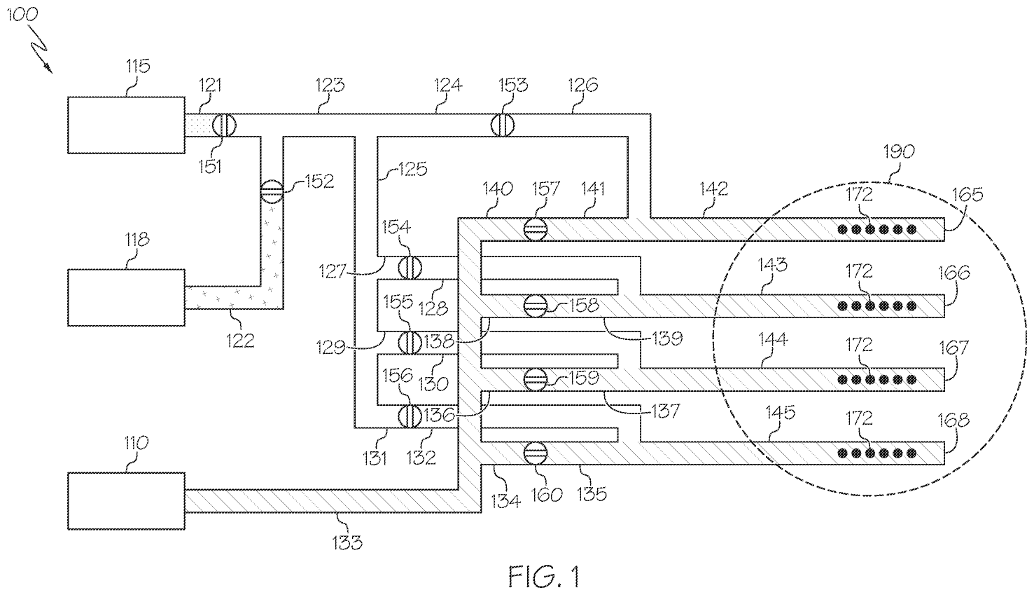

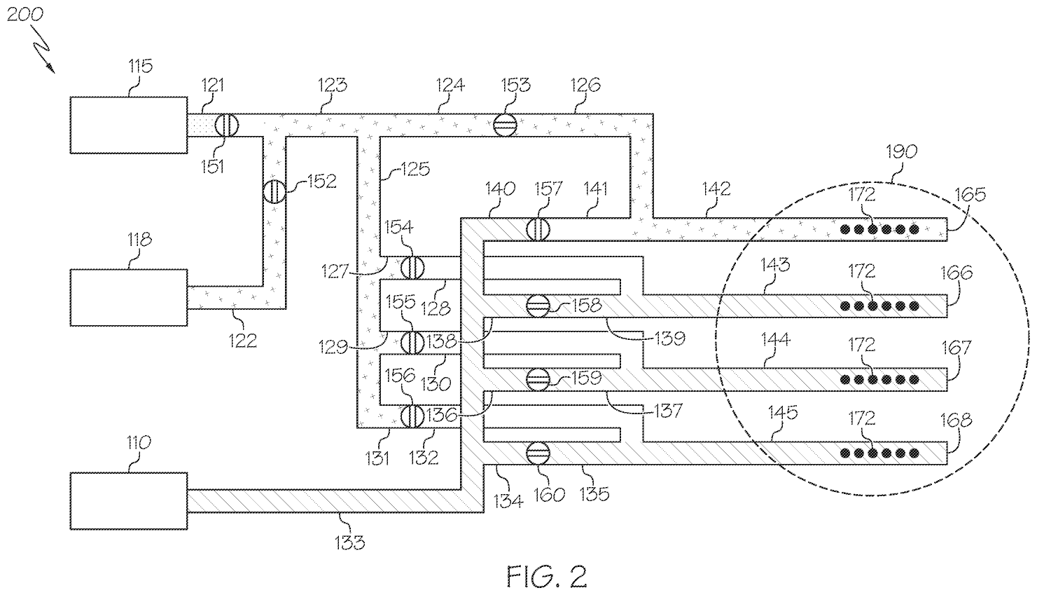

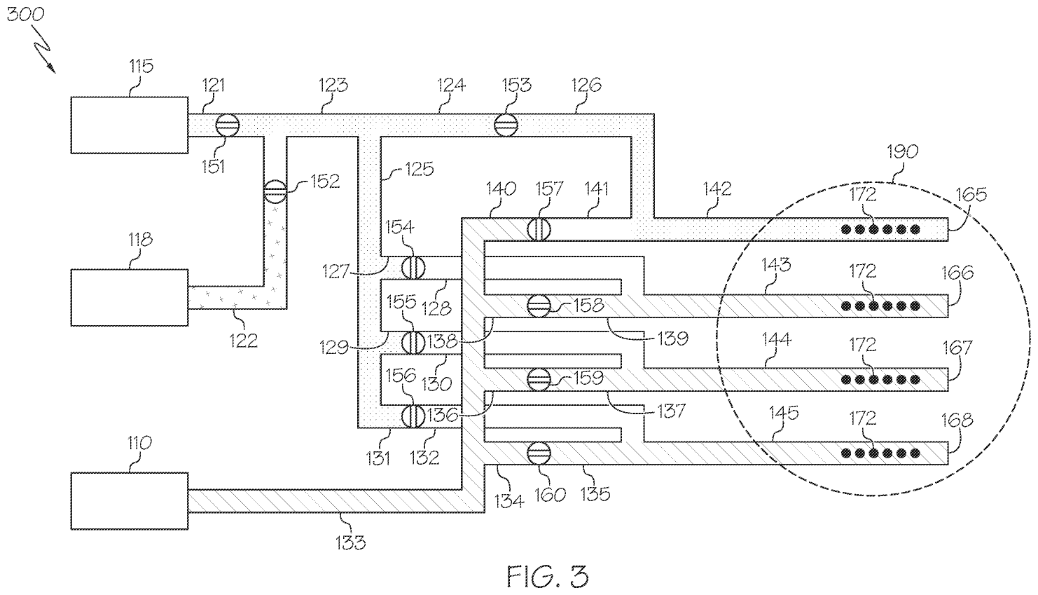

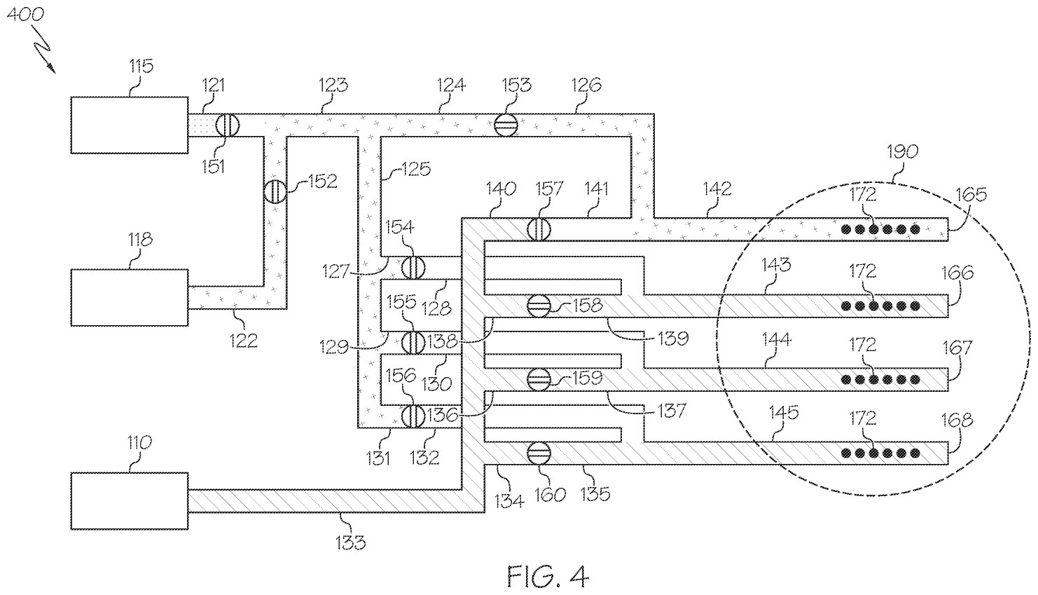

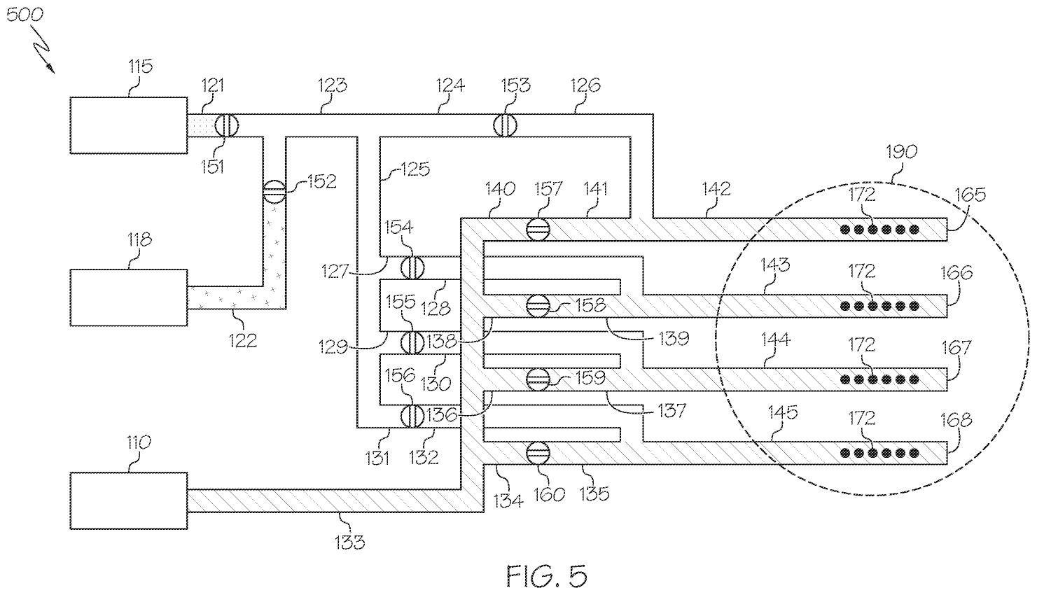

Described herein are methods for operating gas distributors that inject gases into processing units. FIGS. 1-5 each depict different states of operation of the gas distributors, where in general, the operational state of FIG. 1 is followed by the operational state of FIG. 2, which is followed by the operational state of FIG. 3, which is followed by the operational state FIG. 4, which is followed by the operational state FIG. 5. FIG. 1 depicts operation in a “normal state” where all distributors are injecting combustible gas into the processing unit. FIGS. 2-5 depict other states of operation, as are described herein. Generally, FIGS. 2-5 show states of operation where a decoking gas is introduced into a distributor to remove coke, while other distributors maintain the injection of combustible gas. Also shown in some figures is the introduction of purge gas through various distributors. It is noted that FIGS. 1-5 depict the distributors in operational states 100, 200, 300, 400, and 500, respectively. As is described herein with respect to FIGS. 1-5, decoking gas is introduced into only one or some distributors to remove built up coke formed on the distributors, while other distributors remain passing combustible gas. It should be understood that these systems are only examples of applications for the presently disclosed and claimed embodiments.

Referring generally to all of FIGS. 1-5, according to one or more embodiments, multiple distributors 165, 166, 167, and 168 are operable to distribute gases into a processing unit 190. In the embodiments, combustible gas 110, purge gas 118, and decoking gas 115 may be injected into the processing unit 190 through any of the distributors 165, 166, 167, and 168. A piping network, described in detail herein below, connects each of the combustible gas 110, purge gas 118, and decoking gas 115 with the distributors 165, 166, 167, and 168. Valves in the piping network may be turned on or off to regulate fluid flow. As shown in FIGS. 1-5, valves showing a passage in alignment with the piping signify an open valve, and valves showing a passage not in alignment with the piping signify a closed valve. For example, in FIG. 1, valve 151 is closed and valve 157 is open.

As is described herein, in one or more embodiments, the combustible gas 110, the purge gas 118, and the decoking gas 115 may enter the processing unit 190 by passing through one or more distributors 165, 166, 167, and 168. The term “distributor” may refer to a conduit that can pass gases into the processing unit 190 and inject the gas into the processing unit 190 such that the gas is substantially distributed inside the processing unit 190. The gas may pass through the distributor body and exit through orifices 172. In some embodiments, the distributor may comprise at least one orifice 172 that allows the gas in the distributor to exit the distributor and enter the processing unit 190. For example, the distributor may be a cylindrical pipe with multiple orifices 172, the processing unit 190 may be a fluidized bed combustor, and the solid particulate may be a catalyst bed so that when one or more gases are passed through the distributor, the gases then contact the catalyst bed and suspend the catalyst bed so that the bed becomes fluidized. Example distributor systems are described in U.S. Pat. No. 9,889,418, the teachings and disclosures of which are incorporated by reference herein. Additionally, it is noted that the process described herein may be used for a variety of chemical processes, such as heating or decoking catalysts, reducing or oxidizing catalysts, reducing or oxidizing oxygen carrying materials that are not catalysts, etc., for chemical processes such as dehydrogenation, cracking, methanol-to-olefin, or similar chemical processes. Dehydrogenation processes may include the dehydrogenation of light alkanes to form light olefins.

In the methods described herein, solid particulate is passed into the processing unit 190. The combustible gas 110 is also passed to the processing unit 190, which interacts with the solid particulate for a desired result. For example, the combustible gas 110 may be combusted with oxygen, which may heat the solid particulate. Also, the combustible gas 110 may act to reduce the solid particulate. Such processes may regenerate the solid particulate, and the solid particulate may be passed to a reactor for subsequent reaction. The solid particulate may be cycled through a reactor and the processing unit 190 such that the solid particulate is deactivated in the reaction and then regenerated in the processing unit 190.

Referring to FIG. 1, in one or more embodiments, the combustible gas 110 that enters the processing unit 190 through the distributors 165, 166, 167, and 168 may first enter the distributors 165, 166, 167, and 168 at a relatively low temperature, such as at room temperature. The combustible gas 110 may then be heated as the combustible gas 110 passes through the distributors 165, 166, 167, and 168. For example, when the processing unit 190 is a fluidized combustor that contains a catalyst bed as the solid particulate, the reaction temperatures present in the processing unit 190 may heat the combustible gas 110 in the distributors 165, 166, 167, and 168 as the combustible gas 110 flows through the distributors 165, 166, 167, and 168. The combustible gas 110 and the surface of the distributors 165, 166, 167, and 168 may reach a temperature of at least 600° C. In some embodiments, the combustible gas 110 may comprise at least one coke precursor, such as ethylene, where these high temperatures cause the formation of coke on the distributors 165, 166, 167, and 168. The formation of coke may plug one or more orifices 172 of the distributors 165, 166, 167, and 168 that allows the gas in the distributors 165, 166, 167, and 168 to enter the processing unit 190, thus reducing or fully stopping the flowing of gas from the distributors 165, 166, 167, and 168 into the processing unit 190. The formed coke on the distributors 165, 166, 167, and 168 may be removed by passing a decoking gas 115 to the distributors 165, 166, 167, and 168 where coke has formed. The decoking gas 115 may be heated as it passes through the distributors 165, 166, 167, and 168 and contact the formed coke so that the formed coke is oxidized and removed from the distributors 165, 166, 167, and 168.

Now referring to FIGS. 1-5, in one or more embodiments, the combustible gas 110 may be stopped from passing to one or more of the distributors 165, 166, 167, and 168 because of coke buildup on the one or more of the distributors 165, 166, 167, and 168. Before the combustible gas 110 is stopped from passing to the one or more distributors 165, 166, 167, and 168, the purge gas 118 may pass to the one or more distributors 165, 166, 167, and 168, where the combustible gas 110 is then allowed to stop passing to the one or more distributors 165, 166, 167, and 168. The purge gas 118 may be stopped from passing to the one or more distributors 165, 166, 167, and 168. Before the purge gas 118 is stopped from passing to the one or more distributors 165, 166, 167, and 168, the decoking gas 115 may pass to the one or more distributors 165, 166, 167, and 168, where the purge gas 118 is then allowed to stop passing to the one or more distributors 165, 166, 167, and 168. The purge gas 118 may then again be permitted to pass to the one or more distributors 165, 166, 167, and 168, where the decoking gas 115 is then allowed to stop passing to the one or more distributors 165, 166, 167, and 168. The purge gas 118 may be stopped from passing to the one or more distributors 165, 166, 167, and 168. Before the purge gas 118 is stopped from passing to the one or more distributors 165, 166, 167, and 168, the combustible gas 110 may then again be permitted to pass to the one or more distributors 165, 166, 167, and 168. In some embodiments, the one or more distributors 165, 166, 167, and 168 may comprise from one distributor to all distributors (which could include more than the four distributors 165, 166, 167, and 168 depicted in the figures) in the processing unit 190. It should be noted that when any embodiment in this disclosure passes or stops the passing of either the combustible gas 110, the purge gas 118, and/or the decoking gas 115 to one distributor in the processing unit 190, the passing or the stopping of the passing of the combustible gas 110, the purge gas 118, and/or the decoking gas 115 may also occur in at least one or more of the other distributors 165, 166, 167, and 168 in the processing unit 190.

In one or more embodiments, the combustible gas 110 may comprise a hydrocarbon stream. The combustible gas 110 may comprise one or more of hydrogen, nitrogen, methane, ethane, propane, natural gas, combinations thereof, or the like. The combustible gas 110 may comprise one or more olefins. For example, the combustible gas 110 may comprise one or more of ethylene, propylene, butadiene, isoprene, piperylene, combinations thereof, or the like.

In one or more embodiments, the combustible gas 110 may comprise less than 5 mol. % olefins. For example, in one or more embodiments, the combustible gas 110 may comprise less than 5 mol. % olefins, less than 4.5 mol. % olefins, less than 4 mol. % olefins, less than 3.5 mol. % olefins, less than 3 mol. % olefins, less than 2.5 mol. % olefins, less than 2 mol. % olefins, less than 1.5 mol. % olefins, less than 1 mol. % olefins, less than 0.5 mol. % olefins, or even less than 0.1 mol. % olefins.

In one or more embodiments, the combustible gas 110 may comprise at least 30 mol. % nitrogen. For example, in one or more embodiments, the combustible gas 110 may comprise at least 0.1 mol. % nitrogen, at least 1 mol. % nitrogen, at least 2 mol. % nitrogen, at least 5 mol. % nitrogen, at least 10 mol. % nitrogen, at least 20 mol. % nitrogen, at least 25 mol. % nitrogen, at least 29 mol. % nitrogen, or at least 30 mol. % nitrogen.

In one or more embodiments, the purge gas 118 may comprise a gas that is able to remove the combustible gas 110 and/or the decoking gas 115 present in any of the distributors 165, 166, 167, and 168. In some embodiments, the purge gas 118 may comprise nitrogen, steam, or combinations thereof. For example, before passing decoking gas 115 to one or more distributors 165, 166, 167, and 168 in order to remove the formed coke, steam may be passed to the one or more distributors 165, 166, 167, and 168 in order to partially or fully remove the combustible gas 110 from the distributors 165, 166, 167, and 168. In another example, in order to remove decoking gas 115 in the one or more distributors 165, 166, 167, and 168 so that combustible gas 110 can again be passed through the one or more distributors 165, 166, 167, and 168, nitrogen may be passed to the distributors 165, 166, 167, and 168 in order to partially or fully remove the decoking gas 115 from the distributors 165, 166, 167, and 168.

In one or more embodiments, the decoking gas 115 may comprise a gas that is able to contact and remove coke formed on any of the distributors 165, 166, 167, and 168. In some embodiments, the decoking gas 115 may comprise a gas that is able to oxidize the coke formed on any of the distributors 165, 166, 167, and 168. For example, the decoking gas 115 may comprise air, oxygen, steam, or combinations thereof.

In one or more embodiments, the temperature on a surface of at least a portion of the first distributor 165, on a surface of at least a portion of the second distributor 166, on a surface of at least a portion of the third distributor 167, or on a surface of at least a portion of the fourth distributor 168 can reach at least 1000° C. For example, the temperature on a surface of at least a portion of the first distributor 165, on a surface of at least a portion of the second distributor 166, on a surface of at least a portion of the third distributor 167, or on a surface of at least a portion of the fourth distributor 168 may be at least 50° C., at least 100° C., at least 200° C., at least 300° C., at least 500° C., at least 750° C., at least 900° C., at least 990° C., or even at least 1000° C.

In one or more embodiments, the processing unit 190 may comprise a plurality of distributors 165, 166, 167, and 168. For example, the processing unit 190 may comprise the first distributor 165, the second distributor 166, the third distributor 167, and the fourth distributor 168. In one or more embodiments, the processing unit 190 may comprise additional distributors. For example, the processing unit 190 may comprise at least 2 distributors, the processing unit 190 may comprise at least 3 distributors, the processing unit 190 may comprise at least 4 distributors, the processing unit 190 may comprise at least 5 distributors, the processing unit 190 may comprise at least 10 distributors, the processing unit 190 may comprise at least 15 distributors, or the processing unit 190 may even comprise at least 20 distributors.

Now referring to FIG. 1, in one or more embodiments, operational state 100 is depicted. In operational state 100, the injecting of the combustible gas 110 through the plurality of distributors 165, 166, 167, and 168 may comprise passing only the combustible gas 110 to the plurality of distributors 165, 166, 167, and 168. The combustible gas 110 may pass through the first distributor 165, the second distributor 166, the third distributor 167, and the fourth distributor 168. The combustible gas 110 may be passed through the first combustible gas conduit 133 and to the first distributor 165 by passing through the first distributor combustible gas first section 140, passing through valve 157, passing through the first distributor combustible gas second section 141, and passing through the first distributor combined gas section 142. The combustible gas 110 may pass through the first distributor 165 in the processing unit 190 and may contact the solid particulate and form coke on the first distributor 165. The combustible gas 110 may be passed through the first combustible gas conduit 133 and to the second distributor 166 by passing through the second distributor combustible gas first section 138, passing through valve 158, passing through the second distributor combustible gas second section 139, and passing through the second distributor combined gas section 143. The combustible gas 110 may pass through the second distributor 166 in the processing unit 190 and may contact the solid particulate and form coke on the second distributor 166.

In one or more embodiments, the operational state 100 may comprise passing the combustible gas 110 through the first combustible gas conduit 133 and to the third distributor 167 by passing through the third distributor combustible gas first section 136, passing through valve 159, passing through the third distributor combustible gas second section 137, and passing through the third distributor combined gas section 144. The combustible gas 110 may pass through the third distributor 167 in the processing unit 190 and may contact the solid particulate and form coke on the third distributor 167. The combustible gas 110 may be passed through the first combustible gas conduit 133 and to the fourth distributor 168 by passing through the fourth distributor combustible gas first section 134, passing through valve 160, passing through the fourth distributor combustible gas second section 135, and passing through the fourth distributor combined gas section 145. The combustible gas 110 may pass through the fourth distributor 168 in the processing unit 190 and may contact the solid particulate and form coke on the fourth distributor 168.

In one or more embodiments, the operational state 100 may comprise the decoking gas 115 not being passed through to any of the distributors 165, 166, 167, and 168. In one or more embodiments, valve 151 may be closed so that the decoking gas 115 in the first decoking gas conduit 121 does not pass through valve 151. The decoking gas 115 in the first decoking gas conduit 121 may not be permitted to pass to the first distributor 165 by not passing through to the first decoking and purge gas conduit 123, the first distributor decoking and purge gas first section 124, valve 153, the first distributor decoking and purge gas second section 126, and the first distributor combined gas section 142. The decoking gas 115 in the first decoking gas conduit 121 may not be permitted to pass to the second distributor 166 by not passing through the first decoking and purge gas conduit 123, the second decoking and purge gas conduit 125, the second distributor decoking and purge gas first section 127, valve 154, the second distributor decoking and purge gas second section 128, and the second distributor combined gas section 143. The decoking gas 115 in the first decoking gas conduit 121 may not be permitted to pass to the third distributor 167 by not passing through the first decoking and purge gas conduit 123, the second decoking and purge gas conduit 125, the third distributor decoking and purge gas first section 129, valve 155, the third distributor decoking and purge gas second section 130, and the third distributor combined gas section 144. The decoking gas 115 in the first decoking gas conduit 121 may not be permitted to pass to the fourth distributor 168 by not passing through the first decoking and purge gas conduit 123, the second decoking and purge gas conduit 125, the fourth distributor decoking and purge gas first section 131, valve 156, the fourth distributor decoking and purge gas second section 132, and the fourth distributor combined gas section 145.

In one or more embodiments, in operational state 100 purge gas 118 is not passed to any of the distributors 165, 166, 167, and 168. In one or more embodiments, valve 152 may be closed so that the purge gas 118 in the first purge gas conduit 122 does not pass through valve 152. The purge gas 118 in the first purge gas conduit 122 may not be permitted to pass to the first distributor 165 by not passing through to the first decoking and purge gas conduit 123, the first distributor decoking and purge gas first section 124, valve 153, the first distributor decoking and purge gas second section 126, and the first distributor combined gas section 142. The purge gas 118 in the first purge gas conduit 122 may not be permitted to pass to the second distributor 166 by not passing through the first decoking and purge gas conduit 123, the second decoking and purge gas conduit 125, the second distributor decoking and purge gas first section 127, valve 154, the second distributor decoking and purge gas second section 128, and the second distributor combined gas section 143. The purge gas 118 in the first purge gas conduit 122 may not be permitted to pass to the third distributor 167 by not passing through the first decoking and purge gas conduit 123, the second decoking and purge gas conduit 125, the third distributor decoking and purge gas first section 129, valve 155, the third distributor decoking and purge gas second section 130, and the third distributor combined gas section 144. The purge gas 118 in the first purge gas conduit 122 may not be permitted to pass to the fourth distributor 168 by not passing through the first decoking and purge gas conduit 123, the second decoking and purge gas conduit 125, the fourth distributor decoking and purge gas first section 131, valve 156, the fourth distributor decoking and purge gas second section 132, and the fourth distributor combined gas section 145.

Now referring to FIG. 2, according to one or more embodiments, operational state 200 is depicted. In operational state 200, valve 157 may be closed so that the combustible gas 110 does not pass to the first distributor 165. The combustible gas 110 may be permitted to continue to pass to the second distributor 166, the third distributor 167, and the fourth distributor 168 while not permitted to pass to the first distributor 165. While the combustible gas 110 may be permitted to continue to pass to the second distributor 166, the third distributor 167, and the fourth distributor 168, valve 152 and valve 153 may be opened to allow the purge gas 118 to pass to the first distributor 165. In some embodiments, the combustible gas 110 and the purge gas 118 may pass to the first distributor 165 and then valve 157 may be closed so that the combustible gas 110 does not pass to the first distributor 165 while the purge gas 118 continues to pass to the first distributor 165.

Still referring to FIG. 2, in one embodiment, valve 158 may be closed so that combustible gas 110 does not pass to the second distributor 166 while the combustible gas 110 continues to pass to the first distributor 165, the third distributor 167, and the fourth distributor 168. Valve 152 and/or valve 154 may be opened to allow the purge gas 118 to pass through the second distributor 166. In another embodiment, valve 159 may be closed so that combustible gas 110 does not pass to the third distributor 167 while the combustible gas 110 continues to pass to the first distributor 165, the second distributor 166, and the fourth distributor 168. Valve 152 and/or valve 155 may be opened to allow the purge gas 118 to pass through the third distributor 167. In another embodiment, valve 160 may be closed so that combustible gas 110 does not pass to the fourth distributor 168 while the combustible gas 110 continues to pass to the first distributor 165, the second distributor 166, and the third distributor 167. Valve 152 and/or valve 156 may be opened to allow the purge gas 118 to pass through the fourth distributor 168.

Now referring to FIG. 3, operational state 300 is depicted. In operational state 300, after the purge gas 118 passes to the first distributor 165, after valve 152 and/or valve 153 are closed to not allow purge gas 118 to pass to the first distributor 165, and while the combustible gas 110 continues to pass to the second distributor 166, the third distributor 167, and the fourth distributor 168, valve 151 and valve 153 may be opened to allow the decoking gas 115 to pass to the first distributor 165.

Still referring to FIG. 3, in one embodiment, after the purge gas 118 passes to the second distributor 166, after valve 152 and/or valve 154 are closed to not allow purge gas 118 to pass to the second distributor 166, and while the combustible gas 110 continues to pass to the first distributor 165, the third distributor 167, and the fourth distributor 168, valve 151 and valve 154 may be opened to allow the decoking gas 115 to pass to the second distributor 166. In another embodiment, after the purge gas 118 passes to the third distributor 167, after valve 152 and/or valve 155 are closed to not allow purge gas 118 to pass to the third distributor 167, and while the combustible gas 110 continues to pass to the first distributor 165, the second distributor 166, and the fourth distributor 168, valve 151 and valve 155 may be opened to allow the decoking gas 115 to pass to the third distributor 167. In another embodiment, after the purge gas 118 passes to the fourth distributor 168, after valve 152 and/or valve 156 are closed to not allow purge gas 118 to pass to the fourth distributor 168, and while the combustible gas 110 continues to pass to the first distributor 165, the second distributor 166, and the third distributor 167, valve 151 and valve 156 may be opened to allow the decoking gas 115 to pass to the fourth distributor 168.

Now referring to FIG. 4, operational state 400 is depicted. In operational state 400, after the purge gas 118 passes to the first distributor 165, after valve 152 and/or valve 153 are closed to not allow purge gas 118 to pass to the first distributor 165, after the decoking gas 115 passes to the first distributor 165, after valve 151 and/or valve 153 are closed to not allow decoking gas 115 to pass to the first distributor 165, and while the combustible gas 110 continues to pass to the second distributor 166, the third distributor 167, and the fourth distributor 168, valve 152 and valve 153 may be opened to allow the purge gas 118 to pass to the first distributor 165.

In one embodiment, after the purge gas 118 passes to the second distributor 166, after valve 152 and/or valve 154 are closed to not allow purge gas 118 to pass to the second distributor 166, after the decoking gas 115 passes to the second distributor 166, after valve 151 and/or valve 154 are closed to not allow decoking gas 115 to pass to the second distributor 166, and while the combustible gas 110 continues to pass to the first distributor 165, the third distributor 167, and the fourth distributor 168, valve 152 and valve 154 may be opened to allow the purge gas 118 to pass to the second distributor 166. In another embodiment, after the purge gas 118 passes to the third distributor 167, after valve 152 and/or valve 155 are closed to not allow purge gas 118 to pass to the third distributor 167, after the decoking gas 115 passes to the third distributor 167, after valve 151 and/or valve 155 are closed to not allow decoking gas 115 to pass to the third distributor 167, and while the combustible gas 110 continues to pass to the first distributor 165, the second distributor 166, and the fourth distributor 168, valve 152 and valve 155 may be opened to allow the purge gas 118 to pass to the third distributor 167. In another embodiment, after the purge gas 118 passes to the fourth distributor 168, valve 152 and/or valve 156 are closed to not allow purge gas 118 to pass to the fourth distributor 168, after the decoking gas 115 passes to the fourth distributor 168, after valve 151 and/or valve 156 are closed to not allow decoking gas 115 to pass to the fourth distributor 168, and while the combustible gas 110 continues to pass to the first distributor 165, the second distributor 166, and the third distributor 167, valve 152 and valve 156 may be opened to allow the purge gas 118 to pass to the fourth distributor 168.

Now referring to FIG. 5, operational state 500 is depicted. In operational state 500, after the purge gas 118 passes to the first distributor 165, after valve 152 and/or valve 153 are closed to not allow purge gas 118 to pass to the first distributor 165, after the decoking gas 115 passes to the first distributor 165, after valve 151 and/or valve 153 are closed to not allow decoking gas 115 to pass to the first distributor 165, after the purge gas 118 passes again to the first distributor 165, and after valve 152 and/or valve 153 are closed to not allow purge gas 118 to pass to the first distributor 165, valve 157 may be opened to allow the combustible gas 110 to pass through the first distributor 165. In one or more embodiments, the combustible gas 110 and the purge gas 118 may pass to the first distributor 165 before valve 152 and/or valve 153 are closed to not allow purge gas 118 to pass to the first distributor 165.

In one embodiment, after the purge gas 118 passes to the second distributor 166, after valve 152 and/or valve 154 are closed to not allow purge gas 118 to pass to the second distributor 166, after the decoking gas 115 passes to the second distributor 166, after valve 151 and/or valve 154 are closed to not allow decoking gas 115 to pass to the second distributor 166, after the purge gas 118 passes again to the second distributor 166, and after valve 152 and/or valve 154 are closed to not allow purge gas 118 to pass to the second distributor 166, valve 158 may be opened to allow the combustible gas 110 to pass through the second distributor 166. In another embodiment, after the purge gas 118 passes to the third distributor 167, after valve 152 and/or valve 155 are closed to not allow purge gas 118 to pass to the third distributor 167, after the decoking gas 115 passes to the third distributor 167, after valve 151 and/or valve 155 are closed to not allow decoking gas 115 to pass to the third distributor 167, after the purge gas 118 passes again to the third distributor 167, and after valve 152 and/or valve 155 are closed to not allow purge gas 118 to pass to the third distributor 167, valve 159 may be opened to allow the combustible gas 110 to pass through the third distributor 167. In another embodiment, after the purge gas 118 passes to the fourth distributor 168, after valve 152 and/or valve 156 are closed to not allow purge gas 118 to pass to the fourth distributor 168, after the decoking gas 115 passes to the fourth distributor 168, after valve 151 and/or valve 156 are closed to not allow decoking gas 115 to pass to the fourth distributor 168, after the purge gas 118 passes again to the fourth distributor 168, and after valve 152 and/or valve 156 are closed to not allow purge gas 118 to pass to the fourth distributor 168, valve 160 may be opened to allow the combustible gas 110 to pass through the fourth distributor 168.

### EXAMPLES

Examples are provided herein which may disclose one or more embodiments of the present disclosure. However, the Examples should not be viewed as limiting on the claimed embodiments hereinafter provided.

### Example 1—Using Computational Fluid Dynamic Tools to Model Coke Removal Rates and Maximum Tube Metal Temperatures at Various Distributor Air Inlet Temperatures

In the present example, computational fluid dynamics (CFD) tools coupled with the decoking model are used to evaluate the performance of the decoking technique presented in the present specification. Specifically, coke removal rate and tube metal temperature are predicted for one of the eight arms of the fuel gas distributors in the combustor. The geometry and dimensions of the fuel gas distributors are summarized in Table 1. Under the normal operating conditions, the inlet temperature of the fuel gas is at 52° C. at the rate of 214 lb/hr. The combustor temperature is at 730° C. Based on these conditions, as shown in Table 2, the CFD model predicts that the tube metal temperature reaches 700° C. at the end of the distributor where coke is most likely to form. In the CFD model, the coke layer is therefore assumed to be present at the last 6.5 inches of the distributor, with the thickness of 0.5 inches, estimated by the coke formation rate of 3 mg/hr/in² (a conservative estimate of 2 mg/hr/in² suggested by available experimental data at 700° C.) and the duration of 6 months. The corresponding coke mass is 1,296 grams. Based on this initial condition, CFD simulations with the decoking model were performed to predict the coke removal rate and tube metal temperature during the decoking process.

Air is used as the decoking gas at the rate of 880 lb/hr, where the coke removal rate at 4 different air inlet temperatures, 52° C., 250° C., 275° C., and 635° C., are compared. As shown in Tables 3-6, the coke removal rate increases as air inlet temperature increases due to faster decoking kinetics. For the 52° C. case, the model predicts that approximately 30% of the coke is removed in 2 days. It is expected that nearly all coke mass can be removed in 1 week for 1 distributor arm. Based on this result, the total decoking time, defined as the duration in which at least 1 distributor is under decoking mode, will be 8 weeks (2 months) if each of the eight distributors takes 1 week to decoke and only 1 distributor is under decoking mode at a time. If 2 distributors are under decoking mode at the same time, the total decoking time will be reduced to 4 weeks. This demonstrates that it takes at most 2 months to remove coke mass which takes 6 months to build. That is, the overall coke removal rate is at least 3 times faster than the rate of coke formation, which will effectively prevent the coke buildup and eventual plugging of the distributor orifices. The coke removal rate is increased further with increased air inlet temperature. Compared to the 52° C. case, the coke removal rate is 1.35 times, 2.25 times, and 20 times higher for the air inlet temperature of 250° C., 275° C. and 635° C., respectively.

Additional consideration must be taken to ensure that the tube metal temperature is below the design temperature of the tube material, as the decoking reactions are exothermic. The design temperature of the tube material is 800° C. for this case. The maximum tube metal temperature becomes higher when the air inlet temperature is higher, as shown in Tables 7-10. For the 52° C. and 250° C. cases, the maximum tube metal temperature is below 750° C. during the decoking process. For the 275° C. case, the maximum tube metal temperature reaches slightly above 800° C. For the 635° C. case, the maximum tube metal temperature, 1200° C., is well above the design temperature. The results suggest that the decoking air is beneficially pre-heated to at least 52° C. to achieve desirable decoking rate, but not preheated greater than 275° C. to ensure that the maximum tube metal temperature is below the design temperature.

TABLE 1
Dimensions of the modeled fuel gas distributor

| | |
|---|---|
| Pipe Outer Diameter (in.) | 6.625 |
| Pipe Inner Diameter (in.) | 4.897 |
| Pipe Thickness (in.) | 0.864 |
| Pipe Length (in.) | 114.875 |
| Number of Nozzles | 47 |
| Spacing Between Nozzles (in.) | 3.5 |
| Orifice Inner Diameter (in.) | 0.125 |
| Shroud Inner Diameter (in.) | 0.33 |
| Refractory Thickness (in.) | 1 |

TABLE 2
Maximum tube metal temperature along
the axis of a fuel gas distributor

| Axial Location (in.) | Tube Metal Temperature (° C.) |
|---|---|
| 0 | 60 |
| 10 | 70 |
| 20 | 405 |
| 30 | 510 |
| 40 | 545 |
| 50 | 585 |
| 60 | 605 |
| 70 | 620 |
| 80 | 650 |
| 90 | 675 |
| 100 | 680 |
| 110 | 690 |

TABLE 3
Coke removal with an air inlet temperature of 52° C.
Air Inlet Temperature = 52° C.

| Time (hr) | Coke Mass (g) |
|---|---|
| 0 | 1300 |
| 5 | 1250 |
| 10 | 1200 |
| 15 | 1175 |
| 20 | 1150 |
| 25 | 1100 |
| 30 | 1050 |
| 35 | 1010 |
| 40 | 1000 |
| 45 | 975 |
| 50 | 950 |

TABLE 4
Coke removal with an air inlet temperature of 250° C.
Air Inlet Temperature = 250° C.

| Time (hr) | Coke Mass (g) |
|---|---|
| 0 | 1300 |
| 5 | 1275 |
| 10 | 1250 |
| 15 | 1150 |
| 20 | 1100 |
| 25 | 1020 |
| 30 | 1000 |
| 35 | 950 |

TABLE 5
Coke removal with an air inlet temperature of 275° C.
Air Inlet Temperature = 275° C.

| Time (hr) | Coke Mass (g) |
|---|---|
| 0 | 1300 |
| 5 | 1200 |
| 10 | 1100 |
| 15 | 1020 |
| 20 | 950 |

TABLE 6
Coke removal with an air inlet temperature of 635° C.
Air Inlet Temperature = 635° C.

| Time (hr) | Coke Mass (g) |
|---|---|
| 0 | 1300 |
| 5 | 500 |
| 10 | 100 |
| 15 | 75 |
| 20 | 50 |
| 25 | 30 |

TABLE 7
Maximum tube metal temperature with an air inlet temperature of 52° C.
Air Inlet Temperature = 52° C.

| | Maximum Tube Metal |
|---|---|
| Time (hr) | Temperature (° C.) |
| 0 | 718 |
| 5 | 719 |
| 10 | 720 |
| 15 | 721 |
| 20 | 722 |
| 25 | 723 |
| 30 | 724 |
| 35 | 725 |
| 40 | 727 |
| 45 | 726 |
| 50 | 725 |

TABLE 8
Maximum tube metal temperature with an air inlet temperature of 250° C.
Air Inlet Temperature = 250° C.

| | Maximum Tube Metal |
|---|---|
| Time (hr) | Temperature (° C.) |
| 0 | 718 |
| 5 | 719 |
| 10 | 720 |
| 15 | 722 |
| 20 | 723 |
| 25 | 724 |
| 30 | 725 |
| 35 | 727 |
| 40 | 730 |
| 45 | 729 |
| 50 | 727 |

TABLE 9
Maximum tube metal temperature with an air inlet temperature of 275° C.
Air Inlet Temperature = 275° C.

| | Maximum Tube Metal |
|---|---|
| Time (hr) | Temperature (° C.) |
| 0 | 775 |
| 5 | 782 |
| 10 | 790 |
| 15 | 800 |
| 20 | 795 |

TABLE 10
Maximum tube metal temperature with an air inlet temperature of 635° C.
Air Inlet Temperature = 635° C.

| | Maximum Tube Metal |
|---|---|
| Time (hr) | Temperature (° C.) |
| 0 | 1200 |
| 5 | 1075 |
| 10 | 760 |
| 15 | 750 |
| 20 | 730 |
| 25 | 725 |

The present disclosure includes one or more non-limiting aspects. A first aspect includes passing a solid particulate to a processing unit, where the processing unit comprises at least a first distributor and a second distributor, wherein each of the first distributor and second distributor is operable to pass a combustible gas and a decoking gas into the processing unit, passing the combustible gas into the processing unit through the first distributor, wherein the combustible gas is contacted with the solid particulate and coke forms on the first distributor, halting the passing of the combustible gas through the first distributor while the combustible gas is passed through the second distributor, passing the decoking gas through the first distributor while the combustible gas is passed through the second distributor, wherein the decoking gas removes the coke formed on the first distributor, and resuming the passing of the combustible gas through the first distributor.

A second aspect includes any above aspect, further comprising halting the passing of the combustible gas through the second distributor while the combustible gas continues to be passed through the first distributor, passing the decoking gas through the second distributor, wherein the decoking gas removes the coke formed on the second distributor, and resuming the passing of the combustible gas through the second distributor.

A third aspect includes any above aspect, wherein the combustible gas is combusted or reduces the solid particulate in the processing unit when contacted with the solid particulate.

A fourth aspect includes any above aspect, wherein a temperature of a surface of at least a portion of the first distributor or of a surface of at least a portion of the second distributor is at least 500° C.

A fifth aspect includes any above aspect, wherein the combustible gas is continuously passed into the processing unit through the first distributor, the second distributor, or both.

A sixth aspect includes any above aspect, wherein a purge gas is passed through the first distributor after the passing of the combustible gas through the first distributor is halted and prior to passing the decoking gas through the first distributor.

A seventh aspect includes any above aspect, wherein a purge gas is passed through the first distributor after the passing of the decoking gas through the first distributor is halted and prior to the continuing of the passing of the combustible gas through the first distributor.

An eighth aspect includes any above aspect, wherein the purge gas comprises nitrogen or steam.

A ninth aspect includes any above aspect, wherein the combustible gas comprises one or more olefins.

A tenth aspect includes any above aspect, wherein the combustible gas comprises less than 5 mol. % olefins.

An eleventh aspect includes any above aspect, wherein the combustible gas comprises ethylene.

A twelfth aspect includes any above aspect, wherein the combustible gas comprises one or more of hydrogen, nitrogen, methane, ethane, propane, natural gas, or combinations thereof.

A thirteenth aspect includes any above aspect, wherein the decoking gas comprises air, oxygen, steam, or combinations thereof.

A fourteenth aspect includes any above aspect, wherein the processing unit comprises additional distributors where each is operable to pass the combustible gas and the decoking gas into the processing unit.

A fifteenth aspect includes any above aspect, wherein the first distributor, the second distributor, and the additional distributors alternate the passing of decoking gas.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is also noted that recitations herein of “at least one” component, element, etc., should not be used to create an inference that the alternative use of the articles “a” or “an” should be limited to a single component, element, etc.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists” or “consists essentially of” that second component. It should further be understood that where a first component is described as “comprising” a second component, it is contemplated that, in some embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %).

1. A method for operating gas distributors, the method comprising:
passing a solid particulate to a processing unit, where the processing unit comprises at least a first distributor and a second distributor, wherein each of the first distributor and second distributor is operable to pass a combustible gas and a decoking gas into the processing unit;
passing the combustible gas into the processing unit through the first distributor, wherein the combustible gas is contacted with the solid particulate and coke forms on the first distributor;
halting the passing of the combustible gas through the first distributor while the combustible gas is passed through the second distributor;
passing the decoking gas through the first distributor while the combustible gas is passed through the second distributor, wherein the decoking gas removes the coke formed on the first distributor; and
resuming the passing of the combustible gas through the first distributor.

2. The method of claim 1, further comprising:
halting the passing of the combustible gas through the second distributor while the combustible gas continues to be passed through the first distributor;
passing the decoking gas through the second distributor, wherein the decoking gas removes the coke formed on the second distributor; and
resuming the passing of the combustible gas through the second distributor.

3. The method of claim 1, wherein the combustible gas is combusted or reduces the solid particulate in the processing unit when contacted with the solid particulate.

4. The method of claim 1, wherein a temperature of a surface of at least a portion of the first distributor or of a surface of at least a portion of the second distributor is at least 500° C.

5. The method of claim 1, wherein the combustible gas is continuously passed into the processing unit through the first distributor, the second distributor, or both.

6. The method of claim 1, wherein a purge gas is passed through the first distributor after the passing of the combustible gas through the first distributor is halted and prior to passing the decoking gas through the first distributor.

7. The method of claim 1, wherein a purge gas is passed through the first distributor after the passing of the decoking gas through the first distributor is halted and prior to the continuing of the passing of the combustible gas through the first distributor.

8. The method of claim 6, wherein the purge gas comprises nitrogen or steam.

9. The method of claim 1, wherein the combustible gas comprises one or more olefins.

10. The method of claim 9, wherein the combustible gas comprises less than 5 mol. % olefins.

11. The method of claim 1, wherein the combustible gas comprises ethylene.

12. The method of claim 1, wherein the combustible gas comprises one or more of hydrogen, nitrogen, methane, ethane, propane, natural gas, or combinations thereof.

13. The method of claim 1, wherein the decoking gas comprises air, oxygen, steam, or combinations thereof.

14. The method of claim 1, wherein the processing unit comprises additional distributors where each is operable to pass the combustible gas and the decoking gas into the processing unit.

15. The method of claim 14, wherein the first distributor, the second distributor, and the additional distributors alternate the passing of decoking gas.
